(19) United States
(12) Patent Application Publication
(10) Pub. No.: US 2011/0013873 A1
(43) Pub. Date: Jan. 20, 2011

(54) FIBER OPTIC AERIAL DROP CABLE

(76) Inventor: David Keller, Cary, NC (US)

Correspondence Address: SOFER & HAROUN LLP., 317 MADISON AVENUE, SUITE 910, NEW YORK, NY, 10017, US

(21) Appl. No.: 12/502,514

(22) Filed: Jul. 14, 2009

(51) Int. Cl. G02B 6/44

(52) U.S. Cl. 385/113

(57) ABSTRACT

A fiber optic cable has at least two round strength members, at least one fiber optic element, with the strength members and the fiber optic element forms a core. A jacket surrounds the core elements. The strength members are arranged side by side within the jacket such that the inside diameter of the jacket is substantially equal to the combined diameters of the two round strength members and where within the jacket there are two voids not filled by the round strength members. The at least one fiber optic element is positioned in one of the voids the round strength members is dimensioned such that when the fiber optic element is within the void, it does not reach the inside surface of the jacket.

### BACKGROUND

1. Field of the Invention

This application relates to cables. More particularly, this application relates to a fiber optic aerial drop cable.

2. Related Art

In the area of aerial drop cables, when a cable is to be dropped after splicing from a larger line to a terminus point, such as a house or business building, the aerial drop cables typically have both a signal component and a strength component. The strength component bears the weight of the line tension to the terminus point.

Typically aerial drop cables, as shown in FIG. 1, have a flat arrangement, with two GRPs (Glass Reinforced Polymers) on either side of the fiber element, enclosed within a jacket. When such a cable is connected, a wedge clamp is used. These wedge clamps, although effective tend to be of a slighter design and occasionally exhibit mechanical failure.

Aside from the flat drop aerial cables of FIG. 1, using a special wedge clamp, the flat design is atypical relative to other (round) cables and thus requires special handling. For instance, owing to the flat design, it is difficult to bend in various directions, particularly in the plane of the strength members. This makes the cable design difficult to install. An ordinary round cable has a preferred geometry for bending and other mechanical considerations (overall robustness of design) but they can not be used in a wedge clamp.

Separately, a different form of connection joint may be employed for round type aerial drop cable designs (power, signal, etc . . . ) using a dead end connection, particularly a helical type dead end pictured in prior art FIG. 2. A dead end connector typically uses helically wrapped metal wires W that clamp to the end of the cable C and form a loop L to connect to a terminus point.

To attach the clamp to a wire/cable, various strands of pre-wound spiral wires from the end of the dead end are each wrapped around the outer jacket of the cable to be clamped until there is an overall tight fit on the cable. The friction and grip force against the jacket hold the cable within the connector.

However, these pre-wound spiral wires tend to compress against the round outer jacket of the cable until the components within the jacket resist the compression force. Such a connection type can not be used on flat cable designs. And, although such connection styles may be used on round power/copper cables they can not be used on existing round fiber optic cables as the compression force necessary to clamp the dead end to the jacket causes too much compression on the fibers within, resulting in increased chances for attenuation or other such damage to those fibers.

### OBJECTS AND SUMMARY

The present application addresses the issues of the prior art and provides a round style fiber cable, for use in aerial drop applications, that is arranged so that the fiber component is not crushed during a dead end type termination. Such an arrangement allows for the use of preferred round style cables in an aerial drop situation, utilizing a typical round cable connector such as a dead end.

To this end, a fiber optic cable is provided with at least two round members, such as strength members, metallic wires, or insulated copper conductors and at least one fiber optic element, where the strength members and the fiber optic element form a core. A jacket surrounds the core elements. The strength members, metallic wires or insulated copper conductors are arranged side by side within the jacket such that the inside diameter of the jacket is substantially equal to the combined diameters of the two round strength members. Within the jacket there are two voids, not filled by the round strength members. The at least one fiber optic element is positioned in one of the voids. The round strength members are dimensioned such that when the fiber optic element is within the void, it does not reach the inside surface of the jacket.

### BRIEF DESCRIPTION OF THE DRAWINGS

The present invention can be best understood through the following description and accompanying drawings, wherein:

FIG. 1 is a prior art illustration of an aerial drop fiber optic cable;

FIG. 2 is a prior art illustration of an aerial drop dead-end type connection;

FIG. 3 illustrates the internal components of an aerial drop fiber optic cable, in accordance with one embodiment;

FIG. 4 illustrates a circle schematic of the core components of the cable, in accordance with one embodiment;

FIG. 5 illustrates an aerial drop fiber optic cable with a jacket, in accordance with one embodiment; and

FIGS. 6 and 7 illustrate the aerial drop fiber optic cable of FIG. 4 inside of the helical wrap of a dead-end type connection, in accordance with one embodiment.

### DETAILED DESCRIPTION

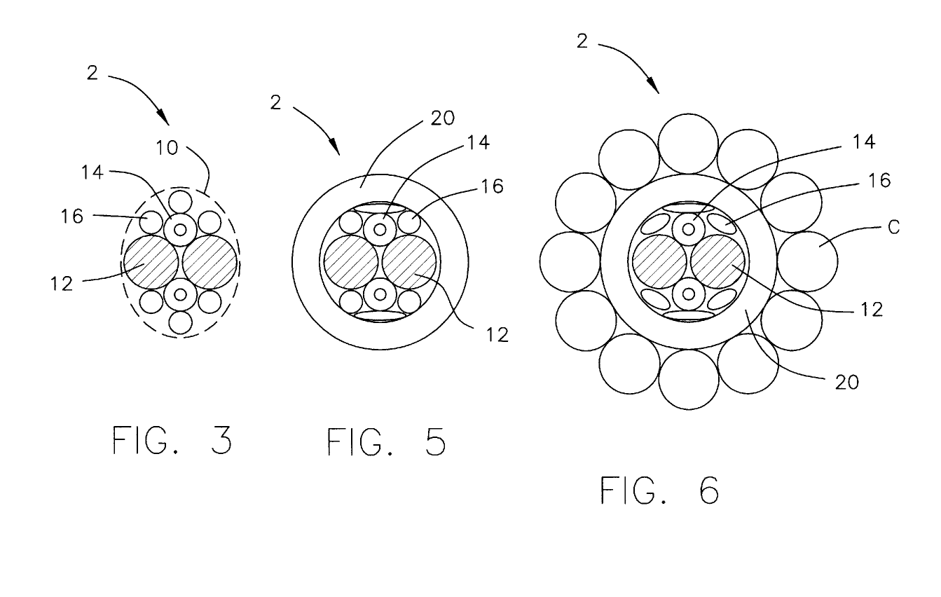

In one arrangement, as shown in FIG. 3, three components are combined to form a core 10 of an aerial drop cable 2. Two GRP (Glass Reinforced Polymers) 12 are arranged in a side by side manner. Both above and below GRPs 12, tight buffer type optical fiber elements 14 are arranged.

It is noted that fiber elements 14 are described herein as tight buffer optical fibers (typically 900 micro outer diameter) however this is for illustration purposes through this specification. In another embodiment, fiber elements 14 may be replaced with loose tube fiber element arrangements with a substantially similarly diametered buffer tube with fibers arranged loosely therein. Additionally, fiber elements may be bare 250 micron coated UV fibers without a loose buffer tube if the environmental conditions for the use of cable 2 support such an arrangement.

Separately, for the purposes of illustrating the salient features of the present invention, the two large elements within core 12 are described as GRPs 12. However, GRPs 12 may be substituted with either bare metallic wires or insulated conductors or a combination of the two depending on the needs of the particular implementation of cable 2. Such bare metallic wires or insulated conductors, would, within the scope of the description below, be dimensioned with substantially similar dimensions to the GRPs 12 discussed in detail below.

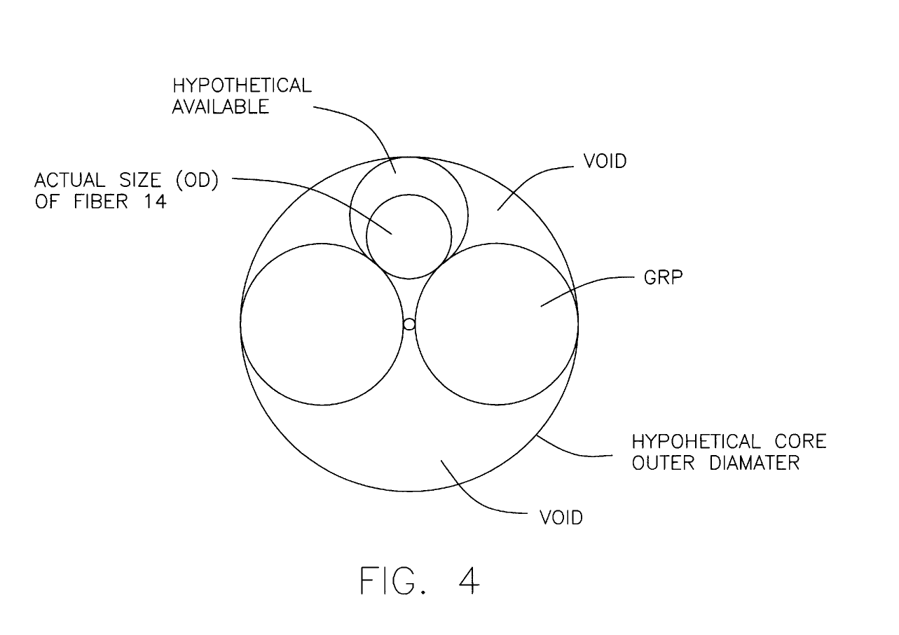

It is noted that when any two round elements are wound together to form a larger hypothetical outer circumference, they generate a bundle diameter (circumference) with 2 voids. If a third hypothetical circle were to be placed in either one of those two voids so that it touches the outer circumference of both round elements as well as the inner circumference of the larger hypothetical circle, that third circle would have a circumference of about ⅔ the diameter of either one of the two round elements. This is illustrated schematically in FIG. 4. The elements (circular) of GRPS 12 and fiber elements 14 are arranged in such a manner in core 10 of cable 2.

However, according to one embodiment as shown in FIGS. 3 and FIG. 5 (circle diagram), GRP 12 elements are sized at approximately 2.1 mm diameter. According to the notes indicated above, such diameters, when stranded in core 10, creates two voids (one above and one below), where each void would create enough space to contain another circle of a diameter of about 1.4 mm (2.1mm×0.67).

However, as noted above, the elements to be placed in these voids are the tight buffer fiber optic elements 14, which are only 0.9 mm.

As a result, when the 0.9 mm optic elements 14 are placed within the voids created by GRPs 12, they only fill about 67% of the available space in this void or in other words are about 33% smaller than they could be before they would contact the hypothetical circle formed by two twisted 2.1 mm GRPs 12.

2.1 mm×0.67=1.4

1.4/0.9 mm=1.5

1.5 (1/x)=0.67

or thus the 0.9 mm tight buffers are 33-34% smaller than the hypothetically available 1.4 mm.

Thus, as shown in FIGS. 3 and 5, the oversized GRPs 12 create a buffer of approximately 33-34% to protect tight buffer fiber elements 14 during compression of cable 2.

Also, as shown in FIG. 3, in addition to GRPs 12 and tight buffer fiber elements 14, core 10 may also include additional water swellable yarns, water swellable powder (with or without yarns) or strength yarns 16. For example, in the arrangement shown in FIG. 3, each of the tight buffer fiber optic elements 12 has three compressible (cushioned) water swellable yarns 16. Compressible yarns 16, like GRPs 14, allow additional space for the diameter of cable 2, under clamping stress, to restrict and tighten down with the pressure being better transferred to GRPs 12 but not to tight buffer fiber optic elements 14.

In one arrangement, yarns are typically 0.15-0.25 mm thick by about 2-2.5 mm wide. It is noted that the yarns are fibrous and thus these dimensions are approximate as the fibers making the yarn may shift/bunch during application. Under the compression of a dead end clamp, yarns 16 may additionally compress to a thickness of 0.10 to 0.15 mm thickness.

It is understood that the sizing of individual yarns 16 may result in more or less than three yarns 16 being used for each fiber optic element 14. Likewise, yarns 16 of different size or compressibility may also be used.

When yarns 16 are placed on top of fiber elements 14 or within the intercies between GRPs 12 and tight buffer fibers 14, they do not significantly decrease the buffer space between the fibers 14/yarns 16 and the inner diameter of the jacket.

For example, 1.407 (hypothetical allowed diameter before touching the inside surface of the jacket/1.05 mm (size of 0.9 mm fiber with 0.15 mm yarn)=about 30-35% additional spacing.

In one arrangement, the elements of core 10, assembled as outlined above, are helically stranded or stranded in an SZ manner in order to provide better flexibility to cable 2. It is understood that the elements of core 10 may be un-stranded if desired, but for the purposes of illustration, the elements of core 10 are helically stranded.

As shown in FIG. 5, once the elements of core 10 are prepared (arranged and stranded) a jacket 20 is extruded thereover forming the completed aerial drop cable design. Jacket 20 may be formed of any desired polymer, such as Polyethylene, PVC or other common jacketing materials.

The outer jacket in one arrangement is about 1.27 mm thick resulting in an OD (Outside diameter of about) 6.74 mm (jacket plus two GRPs 12).

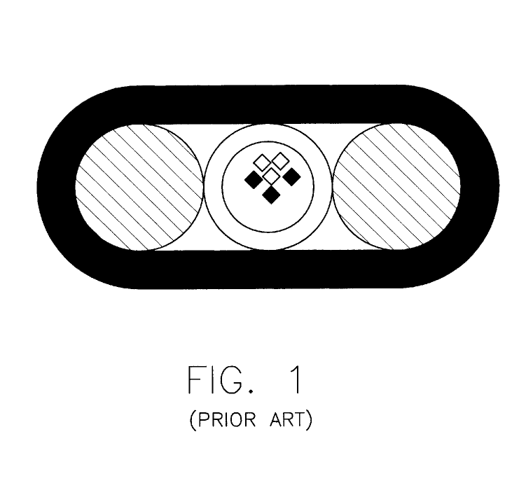

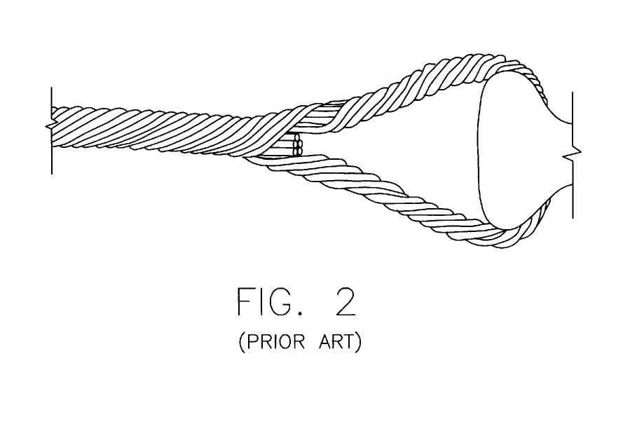

Turning to FIGS. 6 (cross section) and 7 (perspective view), cable 2 is shown within a dead end type clamp, such as that shown in the prior art FIG. 1. In FIG. 5, the various helically wrapped strands of the metal clamp C are shown constricting downward (centrifugally) onto the outer surface of jacket 20, compressing the components of core 10. As shown in FIG. 6, this compression occurs over the entire distance of cable 10 within the dead-end type clamp C.

In one example, the dead end clamp has a pre-spun inner diameter of about 5.5-6 mm. Such a dead end is applied in approximately a quantity of four three-component units at a time by hand wrapping them onto jacket 20 of cable 10. As pre-spun strands go to their pre-spun inner diameter around jacket 20, it causes a compression friction fit. The compression is stopped by the resistance of GRPs 12 and jacket 20.

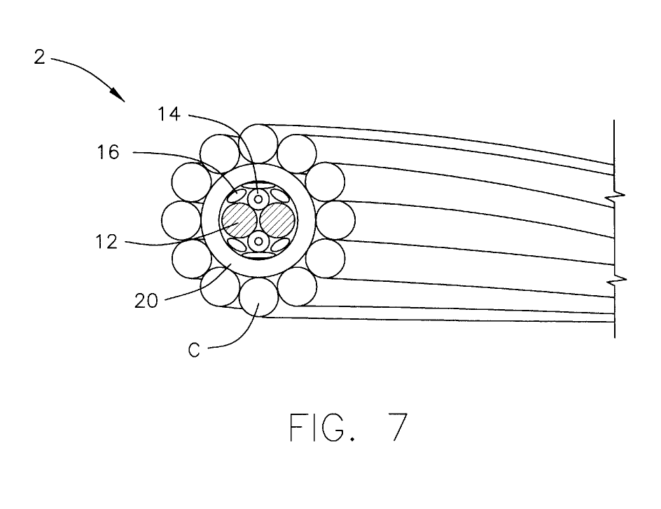

The resultant increased diameter of GRPs 12 and the consequent oversizing of the voids by about 30-34% over tight buffer fiber optic elements 14 prevents the helical wrap of dead-end from crushing the fiber element. For example as shown in FIGS. 6 and 7, the inner diameter of compressed jacket 20 still does not directly press against the outsides of fiber elements 14. The dimensions described above are based on the standard size for dead end connectors. Alternative dimensions for the elements of core 10 and jacket 20 may be used for different sized dead ends.

In one arrangement, it is noted that the various components, particularly yarns 16 and GRPs 12 are helically stranded. Ideally, when the metallic ends of the dead end are wrapped onto jacket 20 the coils should be in an opposite helical lay to the underlying core 10 elements in order to better provide for crush resistance. In any event, the lay is different to such an extent that the GRPs cross the dead end wires in such a way as to provide the anti-compressive structural support.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A fiber optic cable comprising:
at least two round strength members;
at least one fiber optic element, said strength members and said fiber optic element forming a core; and
a jacket surrounding said core elements, wherein said strength members are arranged side by side within said jacket such that the inside diameter of the jacket is substantially equal to the combined diameters of said two round strength members and wherein within said jacket there are two voids not filled by said round strength members, said at least one fiber optic element being positioned in one of said voids said round strength members being dimensioned such that when said fiber optic element is within said void, it does not reach the inside surface of said jacket.

2. The fiber optic cable as claimed in claim 1, wherein said strength members are selected from the group consisting of Glass Reinforced Polymers (GRPs), metallic wires, and insulated conductors.

3. The fiber optic cable as claimed in claim 1, wherein said fiber optic element is a tight buffer optical fiber.

4. The fiber optic cable as claimed in claim 1, wherein said fiber optic element is either one of a buffer tube with coated fibers arranged loosely therein or a bare 250 micron fiber.

5. The fiber optic cable as claimed in claim 1, further comprising two optical fiber elements one positioned in each of said two voids.

6. The fiber optic cable as claimed in claim 5, further comprising a plurality of compressible yarns disposed over the outside of said round strength members and said fiber optic elements within said jacket.

7. The fiber optic cable as claimed in claim 6, wherein said strength members, said fiber optic elements and said yarns are helically stranded within said jacket.

8. The fiber optic cable as claimed in claim 1, wherein said voids created by said two strength members within said jacket include spacing substantially 30-35% larger than the outer diameter of said fiber optic element.

9. The fiber optic cable as claimed in claim 1, wherein said strength members, said voids, said fiber optic element and said jacket are dimensioned such that when a dead-end clamp is wrapped onto an outer surface of said jacket, causing compression, the inner surface of the compressed jacket does not press against the outer surface of the fiber optic element.

10. The fiber optic cable as claimed in claim 9, further comprising a plurality of compressible yarns disposed over the outside of said round strength members and said fiber optic elements within said jacket.

11. The fiber optic cable as claimed in claim 10, wherein said strength members, said fiber optic elements and said yarns are helically stranded within said jacket.

12. The fiber optic cable as claimed in claim 11, where the lay direction of said helically stranded strength members, fiber optic element and said yarns is in a first direction substantially opposite the helical wrap direction that compression attachment arms of said dead-end clamp rotate in.

13. The fiber optic cable as claimed in claim 12, wherein the lay direction of said helically stranded strength members, fiber optic element and said yarns are sufficiently different to such an extent that the GRPs cross wires of the dead end clamp in such a way as to provide said cable with anti-compressive structural support.
